(19) United States
(12) Patent Application Publication
(10) Pub. No.: US 2012/0188539 A1
(43) Pub. Date: Jul. 26, 2012

(54) NANOROD SURFACE ENHANCED RAMAN SPECTROSCOPY APPARATUS, SYSTEM AND METHOD

(76) Inventors: Michael J. Stuke, Palo Alto, CA (US); Shih-Yuan (SY) Wang, Palo Alto, CA (US); Zhiyong Li, Redwood City, CA (US); Min Hu, Sunnyvale, CA (US); Fung Suong Ou, Palo Alto, CA (US); Huei Pei Kuo, Cupertino, CA (US)

(21) Appl. No.: 13/014,683

(22) Filed: Jan. 26, 2011

(51) Int. Cl. G01J 3/44; B82Y 20/00

(52) U.S. Cl. 356/301; 977/954

(57) ABSTRACT

A nanorod surface enhanced Raman spectroscopy (SERS) apparatus, system and method of SERS using nanorods that are activated with a key. The nanorod SERS apparatus includes a plurality of nanorods, an activator to move the nanorods from an inactive to an active configuration and the key to trigger the activator. The nanorod SERS system further includes a Raman signal detector and an illumination source. The method of SERS using nanorods includes activating a plurality of nanorods with the key, illuminating the activated plurality of nanorods, and detecting a Raman scattering signal when the nanorods are in the active configuration.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Detection and identification (or at least classification) of unknown substances have long been of great interest and have taken on even greater significance in recent years. Among methodologies that hold a particular promise for precision detection and identification are various forms of spectroscopy, especially those that employ Raman scattering. Spectroscopy may be used to analyze, characterize and identify a substance or material using one or both of an absorption spectrum and an emission spectrum that results when the material is illuminated by a form of electromagnetic radiation (e.g., visible light). The absorption and emission spectra produced by illuminating the material determine a spectral ‘fingerprint’ of the material. In general, the spectral fingerprint is characteristic of the particular material or its constituent elements (e.g., chemical bonds) facilitating identification of the material. Among the most powerful of optical emission spectroscopy techniques are those based on Raman-scattering.

Raman-scattering optical spectroscopy or simply Raman spectroscopy employs an emission spectrum or spectral components thereof produced by inelastic scattering of photons by an internal structure of the material being illuminated. These spectral components contained in a response signal (e.g., a Raman scattering signal) produced by the inelastic scattering may facilitate determination of the material characteristics of an analyte species including, but not limited to, identification of the analyte. Surface enhanced Raman-scattering (SERS) optical spectroscopy is a form of Raman spectroscopy that employs a Raman-active surface. In general, SERS significantly enhances a signal level or intensity of the Raman scattering signal produced by a particular analyte species. In particular, in some instances the Raman-active surface comprises regions associated with the tips of nanostructures such as, but not limited to, nanorods. The tips of the nanorods may serve as nanoantennas to concentrate an illumination field to further enhance the strength of the Raman scattering signal.

While SERS and SERS using nanorods may be useful in a wide variety of detection and identification applications, there may be instances that require limited or controlled access to SERS results by an authorized user. Such controlled access may be problematic to implement.

### BRIEF DESCRIPTION OF THE DRAWINGS

The various features of examples may be more readily understood with reference to the following detailed description taken in conjunction with the accompanying drawings, where like reference numerals designate like structural elements, and in which:

FIG. 1A illustrates block diagram of a nanorod surface enhanced Raman spectroscopy (SERS) apparatus, according to an example of principles described herein.

FIG. 1B illustrates a perspective view of a nanorod portion of the nanorod SERS apparatus illustrated in FIG. 1A, according to an example of principles described herein.

FIG. 2A illustrates a perspective view of a nanorod having a generally tapered shape, according to an example of the principles described herein.

FIG. 2B illustrates a perspective view of a columnar-shaped nanorod, according to another example of the principles described herein.

FIG. 3A illustrates a side view of an example of the nanorod SERS apparatus in the inactive configuration, according to an example of the principles described herein.

FIG. 3B illustrates a side view of the nanorod SERS apparatus of FIG. 3A following a transition into the active configuration, according to an example of the principles described herein.

FIG. 4A illustrates a side view of another example of the nanorod SERS apparatus in a first configuration, according to an example of the principles described herein.

FIG. 4B illustrates a side view of the nanorod SERS apparatus of FIG. 4A in a second configuration, according to an example of the principles described herein.

FIG. 5A illustrates a cross sectional view of another example of the nanorod SERS apparatus in a first configuration, according to an example of the principles described herein.

FIG. 5B illustrates a cross sectional view of the example nanorod SERS apparatus of FIG. 5A in a second configuration, according to an example of the principles described herein.

FIG. 6 illustrates a side view of a nanorod SERS apparatus having an activator comprising a microelectromechanical system (MEMS) actuator, according to an example of the principles described herein.

FIG. 7 illustrates a block diagram of a nanorod surface enhanced Raman spectroscopy (SERS) system, according to an example of the principles described herein.

FIG. 8 illustrates a flow chart of a method of surface enhanced Raman spectroscopy (SERS) employing nanorods, according to an example of the principles described herein.

Certain examples have other features that are one of in addition to and in lieu of the features illustrated in the above-referenced figures. These and other features are detailed below with reference to the preceding drawings.

### DETAILED DESCRIPTION

Examples according to the principles described herein facilitate surface enhanced Raman spectroscopy (SERS) in a controlled manner. In particular, SERS is performed in conjunction with moving the nanorods from an inactive configuration to an active configuration, according to the various examples. In the active configuration, one or both of production and detection of a Raman scattering signal from an analyte adsorbed on or closely associated with the nanorods is enhanced and, in some examples, strongly enhanced. Conversely, one or both of Raman scattering signal production and detection may be largely suppressed or substantially inhibited when the nanorods are in the inactive configuration. Moreover, in some examples activation of the nanorods is reversible. Further, in some examples, a key is used to activate the nanorods moving them into the active configuration. Using the key allows a timing of the activation to be controlled. In some examples, the controlled activation may further facilitate detection of a Raman scattering signal produced by using a detector that is synchronized with the activation, for example. Additionally, possession and appropriate use of the key may provide that only authorized users are able to perform SERS, according to some examples.

Examples of the principles described herein employ a plurality of nanorods in the active configuration to enhance production and detection of the Raman scattering signal from an analyte. Specifically, an electromagnetic field associated with and surrounding the nanorods (e.g., tips of the nanorods) in the active configuration may enhance Raman scattering from the analyte, in some examples. Further, a relative location of the nanorods or the nanorod tips in the active configuration may provide enhanced Raman scattering. Yet further, an orientation of the nanorods in the active configuration may preferentially direct the Raman scattering signal into a Raman signal detector to enhance detection, in some examples.

By definition herein, the ‘active configuration’ is an arrangement, orientation or configuration of the nanorods that facilitates or, in some examples, enhances one or both of the production and detection of a Raman scattering signal of the adsorbed analyte. The active configuration may represent one or more of a collective location of the nanorods, a relative position of the nanorods with respect to one another, and an orientation of the tips of the nanorods. The tip orientation may be with respect to one or both of an illumination source configured to stimulate emission of the Raman scattering signal and a detector configured to detect the Raman scattered signal, for example. In contrast, the inactive configuration is a configuration that inhibits one or both of the production and detection of the Raman scattering signal.

When the nanorods are in the active configuration, production of the Raman scattering signal may be enhanced by an order of magnitude or more (e.g., many orders of magnitude) when compared to a production while in the inactive configuration, for example. In another example, detection may be enhanced by an order of magnitude or more when the nanorods are in the active configuration as compared to when the nanorods are in the inactive configuration. In yet another example, the active configuration may enhance both the production and detection of the Raman scattering signal.

In some examples, the active configuration may comprise the tips of the nanorods either touching one another or being immediately adjacent or in close proximity to one another. In these examples, the inactive configuration may comprise the tips being separated from one another sufficiently to render relative inactivity. For example, the tips may be within about 1 nanometer (nm) of one another in the active configuration and separated by more than 10 nm in the inactive configuration. In another example, the tips may be within about 2-3 nm in the active configuration and separated by more than about 10-15 nm in the inactive configuration. In another example, the tips may be separated by more than about 90 percent of a major diameter of the tips in the inactive configuration. For example, the tips may have a diameter that is about 10 nm and the separation may be greater than about 9 nm in the inactive configuration. Conversely, in the active configuration the tips may be spaced apart by less than about 50 percent of the tip diameter (e.g., less than 9 nm). In another example, the tips may be separated by more than about 50 percent of the major diameter of the tips in the inactive configuration while in the active configuration the tips may be spaced apart by less than about 20 percent of the tip diameter. In yet another example, the inactive configuration may comprise the tips being separated by more than about 50 percent of the major diameter of the tips while a separation of less than about 10 percent represents the active configuration. In yet another example, the tips may be substantially touching one another in the active configuration and substantially separated from one another (e.g., separated by more than a major diameter of the tips) in the inactive configuration.

In another example, the active configuration may comprise the tips of the nanorods intersecting an illumination (e.g., an optical beam) from the illumination source of a SERS system while the inactive configuration comprises the tips not intersecting the illumination. In yet another example, an angle between the nanorods and various other elements of the SERS system (e.g., a detector) may facilitate detection of the Raman scattering signal in the active configuration. Conversely, the angle between the nanorods and the other elements may substantially prevent or at least hinder detection in the inactive configuration. Various examples of active and inactive configurations are described in further detail below.

A ‘nanorod’ herein is defined as an elongated, nanoscale structure having a length (or height) that exceeds by more than several times a nanoscale cross sectional dimension (e.g., width) taken in a plane perpendicular to the length (e.g., length>about 10× width). In general, the length of the nanorod is much greater than the nanorod width or cross sectional dimension. In some examples, the length exceeds the cross sectional dimension (or width) by more than a factor of 5 or 10. For example, the width may be about 40 nanometers (nm) and the height may be about 400 nm. In another example, the width at a base of the nanorod may range between about 20 nm and about 100 nm and the length may be more than about a 1 micrometer (m). In another example, the nanorod may be conical with a base having a width ranging from between about 100 nm and about 500 nm and a length or height that may range between about one and several micrometers.

In various examples, nanorods of the plurality may be grown (i.e., produced by an additive process) or produced by etching or a subtractive process. For example, the nanorods may be grown as nanowires using a vapor-liquid-solid (VLS) growth process. In other examples, nanowire growth may employ one of a vapor-solid (V-S) growth process and a solution growth process. In yet other examples, growth may be realized through directed or stimulated self-organization techniques such as, but not limited to, focused ion beam (FIB) deposition and laser-induced self assembly. In another example, the nanorods may be produced by using an etching process such as, but not limited to, reactive ion etching, to remove surrounding material leaving behind the nanorods. Various techniques used in the fabrication of micro-electromechanical systems (MEMS) and nano-electromechanical systems (NEMS) are applicable to the fabrication of the nanorods and various other elements described herein.

Herein, ‘spring tension’ is defined as an elastic tension of or imparted to a substantially elastic structure that serves as a spring. In particular, ‘spring tension of a nanorod’ is defined as an elastic tension imparted to the nanorod, or a portion thereof, such that the nanorod acts as a spring. For example, the nanorod with a fixed base may be flexed or bent in a direction that is substantially perpendicular to a long axis of the nanorod extending away from the fixed base. Such a bent nanorod may substantially act or serve as a linear flex-type spring of a cantilever type. That is, when the spring tension is released, the nanorod may elastically return to a position or shape associated with the nanorod prior to it being bent. In other examples, the elastic tension or the spring tension of the nanorod may be one or more of compressive, extensive and torsional.

Further, as used herein, the article ‘a’ is intended to have its ordinary meaning in the patent arts, namely ‘one or more’. For example, ‘a nanorod’ means one or more nanorods and as such, ‘the nanorod’ explicitly means ‘the nanorod(s)’ herein. Also, any reference herein to ‘top’, ‘bottom’, ‘upper’, ‘lower’, ‘up’, ‘down’, ‘front’, back’, ‘first’, ‘second’, ‘left’ or ‘right’ is not intended to be a limitation herein. Herein, the term ‘about’ when applied to a value generally means plus or minus 10% unless otherwise expressly specified. Moreover, examples herein are intended to be illustrative only and are presented for discussion purposes and not by way of limitation.

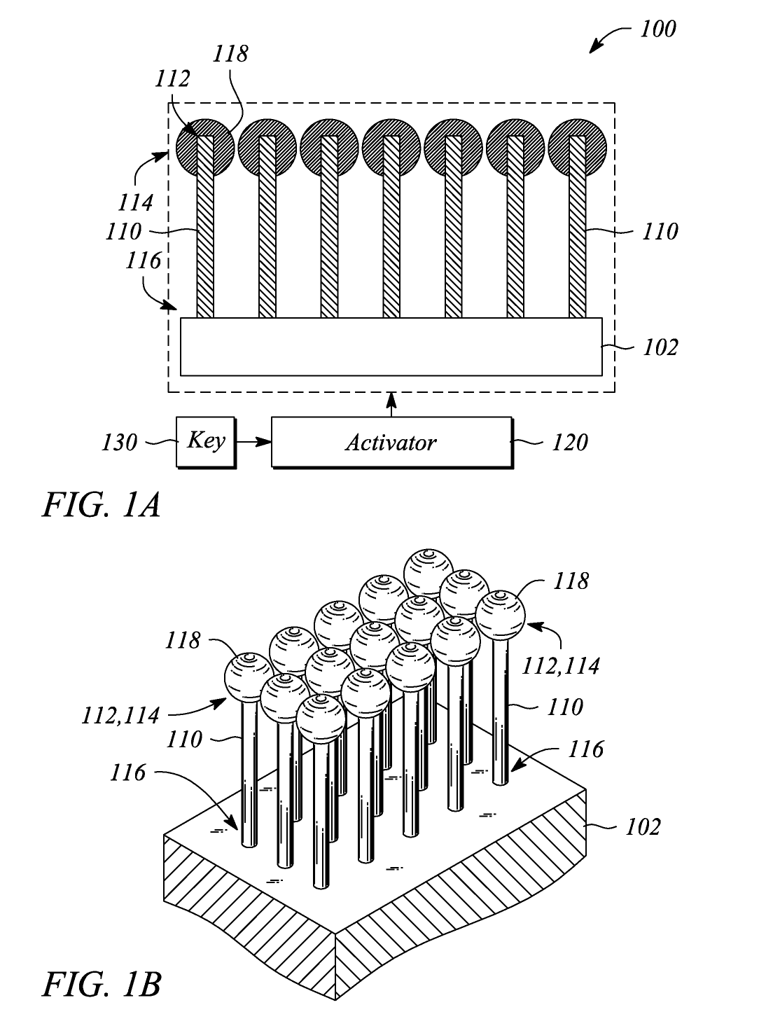

FIG. 1A illustrates block diagram of a nanorod surface enhanced Raman spectroscopy (SERS) apparatus 100, according to an example of the principles described herein. FIG. 1B illustrates a perspective view of a nanorod portion of the nanorod SERS apparatus 100 illustrated in FIG. 1A, according to an example. In particular, the nanorod portion of the SERS apparatus 100 is illustrated on a substrate 102, for example. In some examples, an analyte (not illustrated) may be introduced to and analyzed by the nanorod SERS apparatus 100. For example, the analyte may be introduced by flowing a gas or a liquid containing the analyte along or above the substrate 102 that supports the nanorod portion of the SERS apparatus 100. In some examples, the analyte is adsorbed onto a surface of the nanorods. A Raman scattering signal produced by the adsorbed analyte is detected and analyzed to facilitate analysis (e.g., identification of) the analyte, according to various examples.

As illustrated, the nanorod SERS apparatus 100 comprises a plurality of nanorods 110 arranged in an array. Each nanorod 110 has a tip 112 at a free end 114 opposite to a fixed end 116 of the nanorod 110 that is attached to the substrate 102. The tips 112 of the nanorods 110 are configured to adsorb an analyte. In some examples, the nanorod 110 is rigidly attached to the substrate 102. In other examples (not specifically illustrated in FIGS. 1A and 1B), the nanorod 110 is movably attached to the substrate 102 (e.g., using a hinge). The free end 114 may be configured to move (e.g., side-to-side), according to some examples.

According to some examples, the tip 112 may either be substantially flattened (as illustrated in FIG. 1A) or have a rounded (i.e., domed) shape. For example, the nanorod 110 may have a tip 112 that results naturally from a process (e.g., VLS growth) used to realize the nanorod 110. In other examples, the tip 112 may be further processed to impart a particular shape to the free end 114 of the nanorod 110. The tips 112 of the nanorods 110 may be flattened using chemical-mechanical polishing, for example.

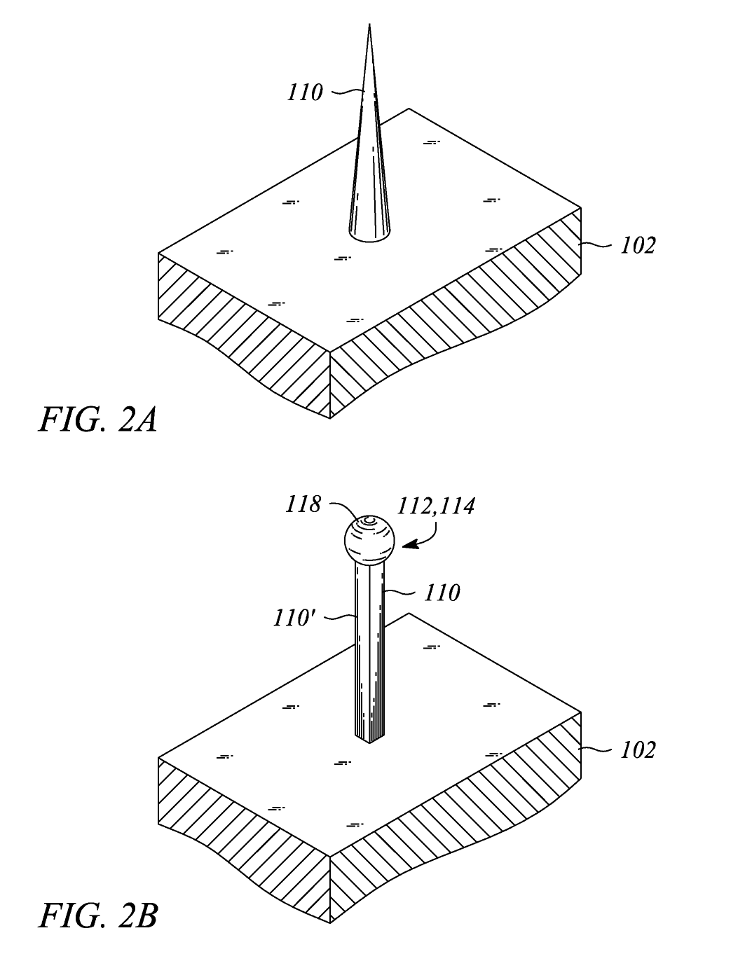

In other examples, the tip 112 is substantially sharp (e.g., as illustrated in FIG. 2A). By ‘sharp’ it is meant that the tip 112 tapers from a cross sectional size of the nanorod 110 to an edge or a point at an end of the tip 112. The edge or the point generally has a relatively acute angle of inflection between surfaces of the tip 112 leading up to the edge or the point. In other words, a cross sectional size of the tip 112 in a vicinity of the end of the tip 112 (i.e., the edge or the point) is much smaller than an overall cross sectional size of the nanorod 110 away from the tip end. As such, the nanorod 110 having a tip 112 that is substantially sharp distinguishes it from other nanorods 110 having rounded or flat tips.

In some examples, the tip 112 may comprise a nanoparticle 118 attached to the free end 114 of the nanorod 110 (e.g., as illustrated in FIGS. 1A and 1B). In some examples, a material of the nanoparticle 118 may differ from a material of the nanorod 110. In some of these examples, the nanoparticle 118 may be configured to one or both of enhance Raman scattering and facilitate selective analyte adsorption (e.g., by functionalization). In particular, in some examples, the nanoparticle 118 comprises a Raman-active material. For example, the nanoparticle 118 may comprise a Raman-active material such as, but not limited to, gold, silver, platinum, aluminum and copper, having a nanoscale surface roughness, as described further herein.

In some examples, the nanorods 110 have a generally tapered shape compared to that illustrated in FIG. 1B. FIG. 2A illustrates a perspective view of a nanorod 110 having a generally tapered shape, according to an example of the principles described herein. In particular, as illustrated in FIG. 2A, the tapered shape of the nanorod 110 is conical. In other examples (not illustrated), the tapered shape may be generally faceted or pyramidal, for example having three, four, or more facets or sides. In yet other examples, the tapered shape may have a curvilinear perimeter when considering a cross section perpendicular to the long axis of the nanorod 110.

In other examples such as that illustrated in FIG. 1B, the nanorod 110 has a generally columnar shape. The columnar portion may have either curvilinear or faceted perimeter in cross section. In particular, with respect to a cross section taken in a plane perpendicular to the long axis of the nanorod 110 and within the columnar portion, the columnar-shaped nanorod 110 may have a cross section that is characterized by either a curvilinear perimeter or a polygonal perimeter. For example, the columnar-portion may have a triangular cross section, a rectangular cross section or a cross section with more than four sides. In another example, the columnar portion may have a perimeter that is circular, oval or similarly curvilinear (e.g., a square with rounded corners). In some examples (not specifically illustrated), the nanorod may resemble a ribbon (e.g., a rectangular ribbon) having a cross sectional shape in which one dimension is much smaller than another, substantially orthogonal dimension (e.g., a thickness that is much less than a width).

FIG. 2B illustrates a perspective view of a columnar-shaped nanorod 110, according to another example of the principles described herein. The long narrow shape may facilitate bending the nanorod as is described below. A columnar portion 110′ of the columnar-shaped nanorod 110 extends from the substrate to near the tip 112. In the vicinity of the tip 112, the columnar portion 110′ is in direct contact with the nanoparticle 118, as illustrated in FIG. 2B. In the example illustrated in FIG. 2B, the columnar-shaped nanorod 110 has a rectangular cross section within the columnar portion 110′ while the nanoparticle 118 has a generally rounded shape (e.g., spherical).

The nanorod 110, whether tapered or columnar, generally has a long narrow profile that extends up from the attachment point at the substrate 102. In particular, the nanorod 110 may be greater than about 5 times longer than it is wide (or thick), according to some examples. In some examples, the nanorod 110 may be at least five times to ten times longer than it is wide. For example, the nanorod 110 may have a width between several nanometers (nm) and about 100 nm and a length that is between about 500 nm and about 1 micrometer (m).

In some examples, the nanorod 110 comprises a Raman-active material. By definition herein, a Raman-active material is a material that facilitates a Raman scattering and the production or emission of a Raman scattering signal from an analyte adsorbed on or in a surface layer of the material during Raman spectroscopy. As mentioned above, examples of Raman-active materials include, but are not limited to, gold, silver, platinum, and other noble metals as well as aluminum and copper. In some examples, the Raman-active materials comprise a layer or layers having nanoscale surface roughness (e.g., generally coated with metal). Nanoscale surface roughness is generally characterized by nanoscale surface features on the surface of the layer(s). Nanoscale surface roughness may be produced spontaneously during deposition of the Raman-active material layer(s) (e.g., gold deposition), for example. In another example, surface roughness may be intentionally induced (e.g., using a laser beam).

In some examples, the nanorod 110 may comprise a semiconductor. For example, the semiconductor may comprise silicon (Si) or germanium (Ge) or an alloy of Si and Ge. In other examples, the semiconductor may comprise gallium arsenide (GaAs), indium gallium arsenide (InGaAs), and gallium nitride (GaN), as well as various other III-V, II-VI, and IV-VI compound semiconductors. In some of these examples, the semiconductor may be doped to render the semiconductor more conductive than an intrinsic or undoped (e.g., unintentionally doped) form of the semiconductor. For example, the Si may be doped with phosphorus (P), an n-type dopant, or boron (B), a p-type dopant, to increase the conductivity of the nanorod.

In some examples, the nanorod 110, or at least a portion thereof, is coated with a layer of the Raman-active material (not illustrated). For example, the nanorods 110 may be coated with a layer of metal such as, but not limited to, gold, silver, platinum, aluminum or copper, since these metals are known as Raman-active materials in conventional SERS. In some examples, the layer of Raman-active material is relatively thin compared to a width or thickness of the nanorod 110. For example, the Raman-active material layer may have a width that is less than about 1/10 of the width of the nanorod 110. The Raman-active material layer may be about 5 to about 10 nm wide, for example.

In some examples, the Raman-active material layer may be confined to or localized in a vicinity of the tips 112 of the nanorods 110. In particular, the Raman-active material may be localized in areas of the nanorods 110 such as, but not limited to, the tips 112 that may be able to come in contact with similar areas of adjacent nanorods 110. In other examples, the Raman-active material layer may extend along more of a length of the nanorods 110 than just a vicinity of the tip 112. For example, a majority of the length, or in some examples, the entire length, of the nanorods 110 may be coated with the Raman-active material layer, according to some examples. In some examples, the Raman-active material layer (e.g., metal) may be annealed or otherwise treated to increase nanoscale surface roughness of the Raman-active material layer after deposition. Increasing the surface roughness may enhance Raman scattering from an adsorbed analyte, for example. In some examples, the Raman-active material layer comprises a layer or layers of nanoparticles. For example, a monolayer of gold nanoparticles may be used to coat the nanorods 110 and produce the Raman-active material layer. The layer(s) of nanoparticles may provide a nanoscale roughness that enhances Raman scattering, for example. In some examples, the Raman-active layer may additionally coat the nanoparticle 118 attached to the tip 112 of the nanorods 110.

In some examples, a surface of the nanorod 110 may be functionalized to facilitate adsorption of the analyte. For example, the tip 112 or portion of the nanorod 110 in a vicinity of the tip 112 may be functionalized (not illustrated) with a binding group to facilitate binding with a specific target analyte species. A surface of the Raman-active material layer on the nanorod 110 at the tip 112 may be functionalized, for example. In another example, a surface of the nanoparticle 118 attached to the nanorod 110 may be functionalized. The functionalized surface (i.e., either a surface of the nanorod 110 itself or a Raman-active material layer coating on one or both of the nanorod 110 and the nanoparticle 118 attached to the tip 112 may provide a surface to which a particular class of analytes is attracted and may bond or be preferentially adsorbed. The functionalized surface may selectively bond with one or more of protein, DNA or RNA, and various hazardous species, for example.

In some examples, the nanorods 110 of the plurality are arranged in a linear array. For example, FIG. 1B illustrates a linear array of nanorods 110. In other examples, the array may be a two dimensional (2D) array. For example, 2D arrays may exhibit three-fold, four-fold, and even higher levels of symmetry. An example 2D array may have nanorods 110 arranged in equally spaced, linear rows and columns, for example. Another example 2D array may be characterized by a triangular arrangement of the nanorods 110. In yet another example, the 2D array may have nanorods 110 arranged in a substantially random or a substantially disordered array.

Referring again to FIG. 1A, the nanorod SERS apparatus 100 further comprises an activator 120. The activator 120 is configured to move the nanorods 110 of the plurality between an inactive configuration and an active configuration when the activator 120 is triggered. The active configuration facilitates one or both of production and detection of a Raman scattering signal emitted by the analyte in a vicinity of the tips 112 of the nanorods 110. Further as illustrated in FIG. 1A, the nanorod SERS apparatus 100 comprises a key 130. The key 130 is configured to trigger the activator 120. In some examples, the key 130, or a portion thereof, may be protected or have a type of restricted access so that only an authorized user may trigger the activator 120.

In some examples, the activator 120 is configured to move the nanorods 110 from the inactive configuration to the active configuration. In other examples, the activator 120 is configured to move the nanorods 110 from an active configuration to an inactive configuration. In yet other examples, movement between the active configuration and the inactive configuration is substantially reversible. In particular, the activator 120 may be configured to move the nanorods 110 one or both of from the inactive configuration to the active configuration and from the active configuration to the inactive configuration. For example, the activator 120 may be triggered to move the nanorods 110 into the active configuration. The activator 120 may then be triggered again to move the nanorods 110 back into the inactive configuration. In some examples, movement between the active configuration and the inactive configuration may be reversibly repeated multiple times.

In some examples, the activator 120 comprises a spring tension of the nanorods 110. For example, the spring tension may be a spring tension associated with a bend in or a bent portion of the nanorods 110. The nanorods 110 may be provided during manufacture with the bent portion or may be bent after manufacturing, for example. While bent, the nanorods 110 may be in the inactive configuration, for example. Releasing the spring tension may allow the nanorods 110 to become substantially straightened. Thus, releasing the spring tension moves the nanorods 110 from the inactive configuration (i.e., bent) to the active configuration (i.e., substantially straightened), for example. In another example, releasing the spring tension moves the nanorods 110 from an initial position to a final position. In these examples, the nanorods 110 may pass through a predetermined position between the initial position and the final position, wherein the predetermined position represents the active configuration, for example.

In some examples, the nanorods 110 are held or constrained in the bent position under spring tension until being triggered. In some examples, the key 130 comprises a latch that constrains the nanorods 110 until the latch is released to trigger the spring tension of the activator 120. The key 130 may also comprise means for using the key 130, for example.

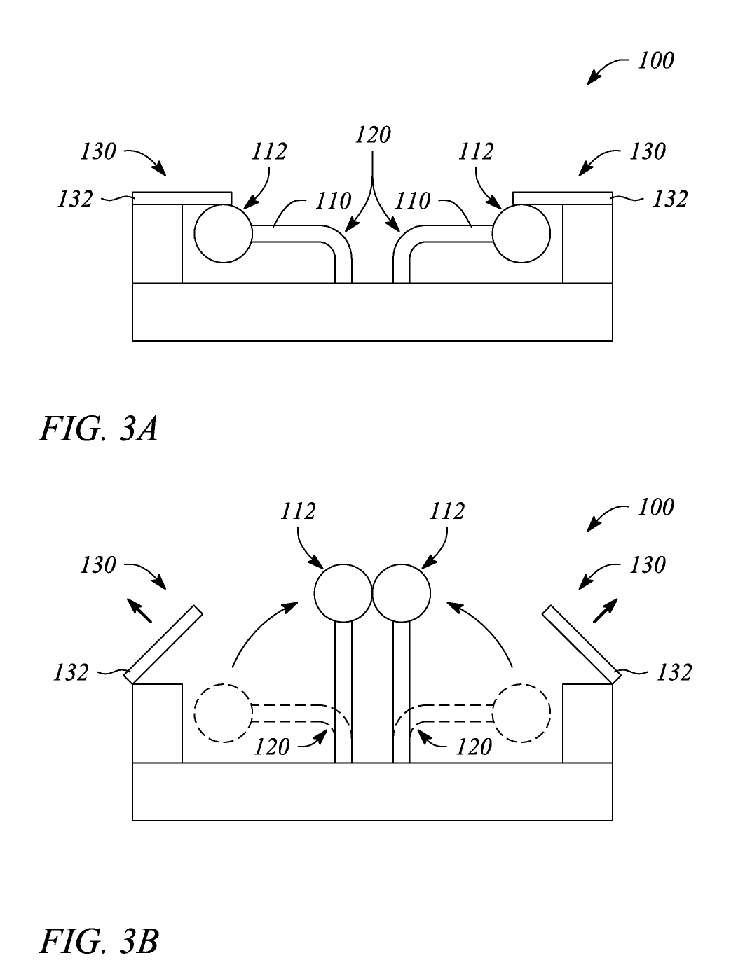

FIG. 3A illustrates a side view of an example of the nanorod SERS apparatus 100 in the inactive configuration, according to an example of the principles described herein. As illustrated, the example in FIG. 3A depicts a pair of nanorods 100 in the inactive configuration in which the nanorods 110 are bent away from one another. In particular, the nanorods 110 are illustrated in FIG. 3A with a bend in a lower middle portion of each nanorod 100. The bend creates the spring tension within the nanorods 110. The bend and the resulting spring tension function as the activator 120, as illustrated.

FIG. 3B illustrates a side view of the nanorod SERS apparatus 100 of FIG. 3A following a transition into the active configuration, according to an example of the principles described herein. In FIG. 3B, the activator 120, which comprises the bend and the spring tension, has been triggered. The spring tension of the activator 120 causes the nanorods 110 to straighten into the active configuration as illustrated in FIG. 3B.

In some examples, the nanorods 110 are held or constrained at the tip 112 by the key 130 comprising a latch 132, as illustrated in FIG. 3A. When the latch is released (as illustrated by a heavy arrow in FIG. 3B), the tips 112 of the nanorods 110 are free to move. In some examples, the key 130 further comprises a mechanism (not illustrated) that releases or otherwise moves the latch 132. The mechanism may comprise a fusible link or fusible structure that melts or otherwise breaks down to release the latch. The fusible structure may be activated by applying a voltage to the structure, for example. In another example, illuminating the fusible structure with a laser or another properly timed light beam of suitable intensity to substantially ‘burn’ or evaporate away a portion of the fusible structure may be used to release the latch 132. In yet another example, the fusible structure may be broken down by dissolving the fusible structure or a portion of thereof with a suitable solvent. An authorized user may be given specific instructions regarding how to employ the mechanism (e.g., what voltage to apply, which solvent to use, etc.) to release the latch 132, for example. In these examples, the key 130 may further comprise the instructions that represent means for using the key 130.

In another example, the mechanism may comprise an electromagnetic force (e.g., provided by an electrode) that moves the latch 132 and releases the spring tension of the activator 120. In these examples, the key 130 may further comprise one or more electrodes and a power source to energize the electrode(s), for example. In yet other examples, the latch 132 may be moved by other means such as, but not limited to, a microelectromechanical system (MEMS) gear or even a MEMS motor. For example, a MEMS linear motor may be employed to either move the latch 132 or to release the latch 132. In these examples, the key 130 may further comprise the MEMS gear or MEMS motor, as well as may further comprise instructions that enable only an authorized user to move or release the latch 132.

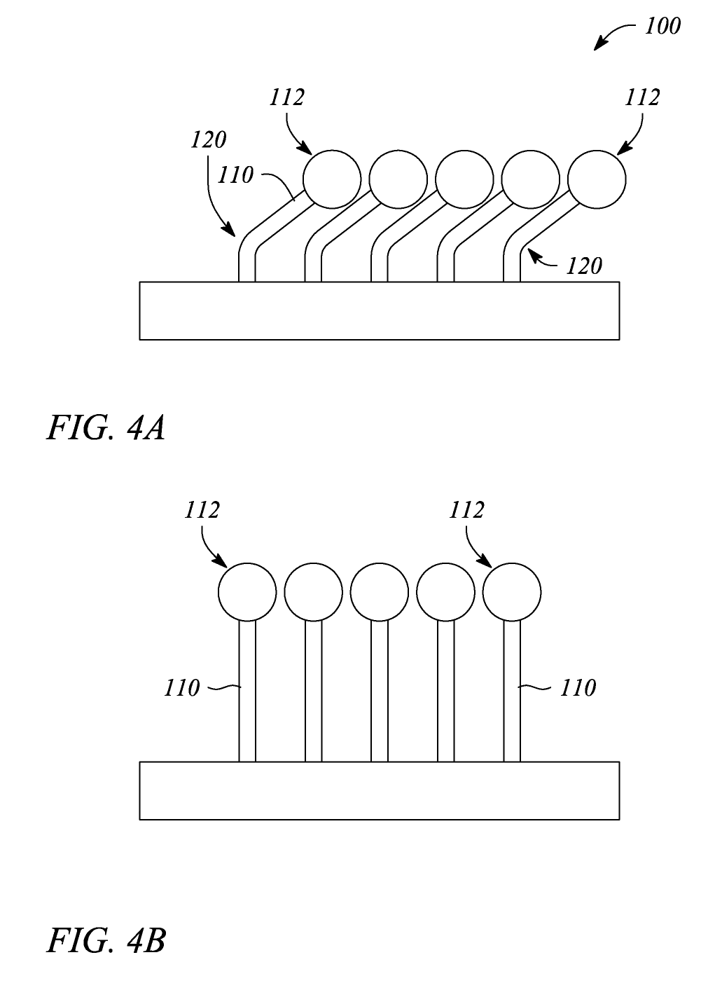

FIG. 4A illustrates a side view of another example of the nanorod SERS apparatus 100 in a first configuration, according to an example of the principles described herein. As illustrated in FIG. 4A, the activator 120 comprises spring tension in the bent nanorods 110 to provide an inactive configuration, for example. FIG. 4B illustrates a side view of the nanorod SERS apparatus 100 of FIG. 4B in a second configuration, according to an example of the principles described herein. As illustrated in FIG. 4B, the activator 120 has been triggered and the spring tension of the activator 120 has been released. In this example, the nanorods 110 are extended or straightened in an active configuration with tips 112 of the nanorods in close proximity without contacting one another. In these and other examples described herein, the active configuration may further comprise the tips 112 of adjacent nanorods 110 being in contact with one another (as illustrated in FIG. 3B, for example). In other examples, the active configuration may further comprise the tips 112 of the nanorods 110 being in an optical beam of an illumination source (illustrated in FIG. 7), whether the tips 112 are in contact or not. In yet another example, the active configuration may further comprise the tips 112 of the nanorods 110 in a location that maximizes collection of a Raman scattering signal by a detector (illustrated in FIG. 7). For example, the location may establish a preferential angle between the detector, an illumination source and the tips 112 that facilitates detection of the Raman scattering signal. In FIGS. 4A and 4B, the key 130 is omitted for simplicity of illustration. The key 130 is omitted from FIGS. 4A and 4B for clarity of illustration.

In some examples, the activator 120 comprises a bi-metallic material of the nanorods 110. The bi-metallic material comprises a plurality of metal layers that differ from one another (i.e., in particular, with respect to their respective thermal expansion coefficients). The layers may extend lengthwise along a length of the nanorod 110 as further described below, for example. The metal layers differ by comprising different metals having different coefficients of expansion, for example. A differential in the coefficient of expansion of the different metals causes the nanorod 110 to bend or flex as a function of temperature. The temperature-dependent flexing of the nanorods 110, in turn, moves the tips 112 of the nanorods 110 as a function of temperature. In particular, the tips 112 of the nanorods 110 may move between an inactive position and an active position in response to or as a function of a change in temperature, for example.

In these examples, one or both of a particular or predetermined temperature and the application of the temperature to the nanorods 110 may comprise the key 130 that triggers the bi-metallic material serving as the activator 120 to move the nanorods 110 from the inactive configuration to the active configuration. In various examples, the predetermined temperature may be applied by various means including, but not limited to, exposing the nanorods 110 to an environment at the predetermined temperature and subjecting the nanorods 110 to a suitable energetic pulse (e.g., a laser beam) that induces the predetermined temperature directly in the nanorods 110.

In some examples, the bi-metallic material may comprise a coating on one or more surfaces of the nanorods 110. For example, the bi-metallic material may comprise a layer of a first metal on a first surface and a layer of a second metal on a second, opposing surface of the nanorod 110. In another example, the first and second metals may be in layers on just the first side of the nanorod 110. In other examples, the nanorods 110 may comprise the bi-metallic material as a structural component of the nanorods 110 themselves. For example, the nanorods 110 may be made from two metals having an interface between the metals that extends a length of the nanorod 110.

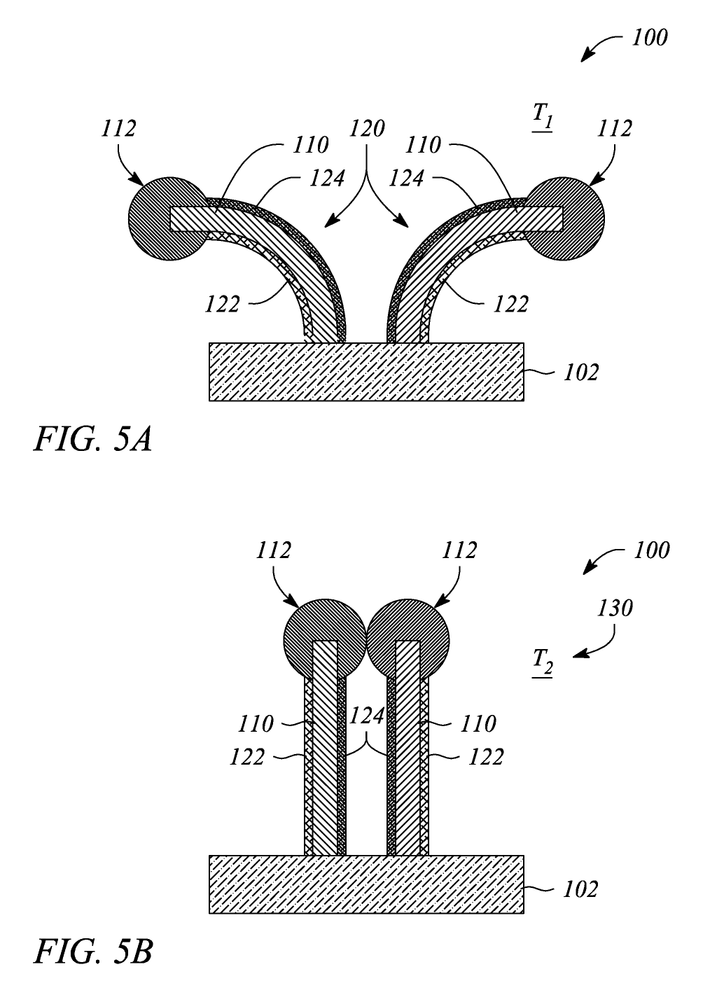

FIG. 5A illustrates a cross sectional view of another example of the nanorod SERS apparatus 100 in a first configuration, according to an example of the principles described herein. The first configuration may be an inactive configuration, for example. In particular, as illustrated in FIG. 5A, the actuator 120 comprises a bi-metallic material having a first layer 122 of a first metal on a first surface and a second layer 124 of a second metal on a second surface of the nanorods 110. The nanorods 110 are further illustrated as affixed to a substrate 102. FIG. 5A illustrates the nanorods 110 exposed to a first temperature T₁ at which the differential coefficients of expansion of the first metal and the second metal flex the nanorods 110 to impart a bend therein. The bend provided by the first temperature T₁ may position the nanorods 110 in the inactive configuration (e.g., bent away from one another), for example.

FIG. 5B illustrates a cross sectional view of the example nanorod SERS apparatus 100 of FIG. 5A in an active configuration, according to an example of the principles described herein. In particular, the nanorod SERS apparatus 100 of FIG. 5B is illustrated at or exposed to a second temperature T₂. The second temperature T₂ changes the flexing of the nanorods 110 as compared to that illustrated in FIG. 5A such that the nanorods 110 are positioned in an active configuration. For example, the active configuration may comprise the tips 112 of adjacent nanorods 110 being in contact with one another as illustrated in FIG. 5B. In other examples (not illustrated), the active configuration achieved using the second temperature T₂ may flex the nanorods 110 to move the tips 112 of the nanorods 110 into an optical beam of an illumination source, whether the tips 112 are in contact or not. In yet another example (not illustrated), the second temperature T₂ may move the tips 112 of the nanorods 110 to a location that maximizes collection of a Raman scattering signal by a detector. For example, the location may establish a preferential angle between the detector and the tips 112 that facilitates detection of the Raman scattering signal. Further, by again exposing the nanorods 110 to the first temperature T₁, the nanorods 110 may reversibly return to inactive configuration, according to some examples.

In various examples that employ the bi-metallic material as the activator 120, the key 130 may comprise the predetermined temperature or a predetermined change in temperature that places the nanorods 110 in the active configuration. For example, the key 130 may comprise the second temperature T₂, described above, as an activation temperature. Hence, when the key 130 comprising the second temperature is applied to the nanorods 110, the bi-metallic material of the activator 120 bends the nanorods 110 into the active configuration. The key 130 may further comprise information designating or identifying the activation temperature and an inactivation temperature. With knowledge of the activation temperature, a user may activate and use the nanorod SERS apparatus 100. Unauthorized users may be prevented from using the nanorod SERS apparatus 100 by withholding the information specifying the activation temperature, for example. Moreover, knowledge of the inactivation temperature allows the user to inactivate the nanorod SERS apparatus 100 when a SERS task is completed, for example.

In some examples, the activator 120 comprises a microelectromechanical system (MEMS) actuator. For example, the MEMS actuator may comprise a MEMS hinge between the fixed ends of the nanorods 110 and a substrate that supports the nanorods 110. The hinge enables an angle between the nanorods 110 and the substrate 102 to be varied. Varying the angle facilitates movement of the nanorods 110 between the inactive configuration and the active configuration. In some of these examples, the MEMS actuator may further comprise a motivator that exerts a force on the nanorods 110 to provide the movement. An example of a motivator is an electromagnetic (EM) field. The electromagnetic field (e.g., a static electric field) may be provided by an electrode adjacent to the nanorods 110. In this example, the nanorods 110 may function as a second electrode. In another example, a plurality of electrodes may be used to generate the EM field that moves the nanorods 110. The activator 120 comprising a MEMS actuator is another example of an activator 120 that may be used to reversibly move the nanorods 110 between the active and inactive configurations.

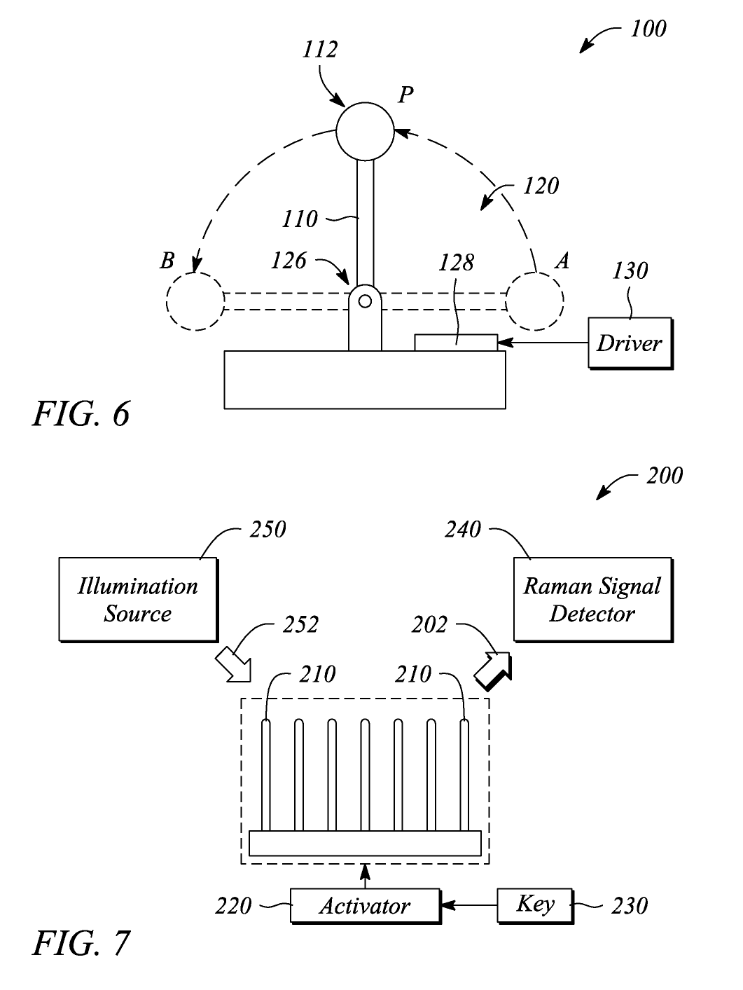

FIG. 6 illustrates a side view of a nanorod SERS apparatus 100 having an activator 120 comprising a microelectromechanical system (MEMS) actuator, according to an example of the principles described herein. As illustrated, the activator 120 comprises a MEMS hinge 126 that connects between the nanorods 110 and a substrate 102, for example. In some examples, the nanorods 110 of the plurality are arranged in a linear array extending into the page such that only one nanorod 110 is visible in FIG. 6. In some examples, each nanorod 110 may have a separate hinge 126. In other examples, more than one nanorod 110 (e.g., all of the nanorods 110) may share a hinge 126.

The activator 120 further comprises an electrode 128. The electrode 128 is configured to produce an EM field that applies an electromotive force to the nanorods 110. For example (as illustrated), the electrode 128 may comprise a metal strip on a surface of the substrate 102 that runs parallel to the nanorods 110 arranged in a linear array. In another example, other electrode configurations may be employed including, but not limited to, individual electrodes for each nanorod 110 and pairs of electrodes disposed on opposite sides of the nanorods 110. The electromotive force moves the nanorods 110 from an inactive configuration to an active configuration as indicated by the dashed-line curved arrow in FIG. 6. Further, as illustrated, the hinge 126 provides a pivot point to facilitate movement of the nanorods 110 by the electromotive force.

In particular as illustrated in FIG. 6, the active configuration comprises a predetermined position P of the nanorods 110 between a first position A and a second position B. As illustrated, the active configuration comprises a vertical orientation of the nanorods 110 while inactive configurations of the nanorods 110 at the first position A and the second position B are illustrated using dashed outlines in FIG. 6. In some examples, when activated the nanorods 110 are moved one time from the first or initial position A through the predetermined position P of the active configuration to the second or final position B. In other examples, the nanorods 110 may be moved multiple times between the first and second positions A, B through the active configuration at the predetermined position P.

In some examples, the key 130 comprises a driver that drives the electrode 128. The driver may be an electronic circuit connected to the electrode 128, for example. In some examples, circuitry of the driver may require a predetermined signal or code for activation. In particular, the code may need to be input to the driver before the driver is activated and to produce a voltage to drive the electrode 128, for example. As such, the key 130 may further comprise the code. Lacking the code, an unauthorized user may be prevented from using the nanorod SERS apparatus 100, for example.

While not explicitly illustrated in FIG. 6, in some examples the active configuration may comprise a predetermined angular relationship between a Raman signal detector and the nanorods 110 of the nanorod SERS apparatus 100. In particular, only when the nanorods 110 are located at a predetermined location (e.g., position P) along an arc of travel of the nanorods 110 (illustrated by the dashed-line curved arrow) will a Raman scattering signal produced by an analyte be preferentially directed into the Raman signal detector. When the Raman scattering signal is preferentially directed into the Raman signal detector, the Raman scattering signal is detected. At other positions, the Raman scattering signal is not directed into the Raman signal detector and therefore, may not be detected. The predetermined location may be established by a relative location of the nanorods 110 and the Raman signal detector, for example. In yet other examples (not illustrated) the predetermined position is provided by a relative location of both of an illumination source and the Raman signal detector with respect to the nanorods 110. In some examples, the key 130 may further comprise the predetermined position of one or both of the illumination source and the Raman signal detector with respect to the active configuration of the nanorods 110 for authorized use of the SERS apparatus 100.

FIG. 7 illustrates a block diagram of a nanorod surface enhanced Raman spectroscopy (SERS) system 200, according to an example of the principles described herein. According to some examples, the nanorod SERS system 200 detects and analyzes an analyte using a Raman scattering signal 202 emitted by the analyte. In particular, an active configuration of the nanorod SERS system 200 may facilitate detection of the Raman scattering signal emitted by the analyte.

As illustrated, the nanorod SERS system 200 comprises a plurality of nanorods 210 arranged in an array. The array may be a linear array comprising a row of adjacent nanorods 210, for example. In another example, the array may comprise a plurality of rows of nanorods 210. In yet other examples, the nanorods 210 may be arranged in other arrays including, but not limited to, circular arrays and random arrays. Each nanorod 210 has a tip at a free end opposite to an end of the nanorod 210 that is attached to a substrate. The tips of the nanorods 210 are configured to adsorb the analyte.

In some examples, the nanorods 210 are substantially similar to the nanorods 110, described above with respect to the nanorod SERS apparatus 100. In particular, in some examples, the nanorods 210 comprise a nanoparticle attached to the tip, the nanoparticle being configured to adsorb the analyte. In some examples, the tips of the nanorods 210 comprise a Raman-active material layer configured to further enhance the Raman scattering signal emitted by the analyte.

The nanorod SERS system 200 illustrated in FIG. 7 further comprises an activator 220. The activator 220 is configured to move the nanorods 210 of the plurality between an inactive configuration and an active configuration. The activator 220 moves the nanorods 210 when the activator 220 is triggered by a key 230. The inactive and active configurations are substantially similar to those described above with respect to the nanorod SERS apparatus 100, according to some examples. According to some examples, the activator 220 may be substantially similar to the various example activators 120 described above with respect to the nanorod SERS apparatus 100. Moreover, the key 230 may be substantially similar to the key 130 described above, in some examples.

In particular, according to some examples, the activator 220 may comprise a spring tension in the nanorods 210 that when released allows the nanorods 220 to change from a first, inactive position to a second, active position. For example, bent nanorods in an inactive configuration may become substantially straightened into the active configuration. According to these examples, the nanorods 210 are in the inactive configuration prior to being released. In some examples, the key 230 comprises a latch that constrains the nanorods 210 in the inactive configuration until the latch is released. In some examples, the key 230 may further comprise steps, signals, or other inputs to the nanorod SERS system 200 that are necessary to release the latch. Thus, the key 230 may insure that only an authorized user employs the nanorod SERS system 200 to detect and analyze the analyte, in some examples.

In other examples, the activator 220 may comprise a MEMS actuator and the key 230 may comprise a driver that controls the MEMS actuator 220. The MEMS actuator 220 and the related driver of the key 230 may be substantially similar to those the actuator 120 and the key 130 described above with respect to FIG. 6 and the nanorod SERS apparatus 100, for example. In yet other examples, the activator 220 may comprise a bi-metallic material of the nanorods 210 and the key 230 may comprise a predetermined temperature, for example. The bi-metallic material and its use in conjunction with the nanorods 210 as well as the key 230 comprising a predetermined temperature may be substantially similar to the bi-metallic material and predetermined temperature described above with respect to FIGS. 5A-5B and the nanorod SERS apparatus 100, for example.

As illustrated in FIG. 7, the nanorod SERS system 200 further comprises a Raman signal detector 240. The Raman signal detector 240 is configured to receive the Raman scattering signal 202 from the analyte adsorbed on the tip of the nanorods 210 when the nanorods 210 are in the active configuration. As has already been discussed, the active configuration may comprise a predetermined position of the nanorods 210 relative to the Raman signal detector 240, according to some examples. The predetermined position may establish an angle between the nanorods 210 and the Raman signal detector 240 that preferentially directs the Raman scattered signal from the analyte into the Raman signal detector 240.

For example, the active configuration may comprise the nanorods 210 being in a substantially straightened configuration while the inactive configuration may comprise the nanorods 210 being bent. In another example, the active configuration may comprise a position along an arc of travel of the nanorods 210 as the nanorods 210 move from a first (e.g., initial) position to a second (e.g., final) position. In any case, the active configuration facilitates one or both of production and detection (e.g., by the Raman signal detector 240) of the Raman scattering signal 202 emitted by the analyte. Further, a timing of the movement or transition from the inactive configuration to the active configuration may also facilitate detection (e.g., using a Raman signal detector 240 that is synchronized with the movement), according to some examples. Likewise, movement of the nanorods 210 between the active and inactive configurations may be substantially reversible.

In some examples, the Raman signal detector 240 may be a synchronous detector that is synchronized to the activation of the nanorods 210 by the activator 220. For example, the Raman signal detector 240 may be synchronized to detect the Raman scattering signal 202 only when the nanorods 210 pass through the active configuration (e.g., the position along the arc of travel). In another example, the Raman signal detector 240 may be synchronized to detect the Raman scattering signal 202 only after the nanorods 210 are in the active configuration (e.g., substantially straightened).

In some examples, the nanorod SERS system 200 further comprises an illumination source 250. The illumination source 250 is configured to illuminate the tips of the nanorods 210. The illumination source 250 may emit an illumination signal 252 comprising a beam of electromagnetic (EM) radiation (e.g., an optical beam or optical signal) having a frequency that stimulates emission of the Raman scattering signal 202 by the analyte, for example. In some examples, the illumination source 250 may comprise a laser and the illumination signal 252 may comprise a laser beam. In other examples, the illumination source 250 may be other means for generating the EM radiation (e.g., a light emitting diode or an incandescent light source).

In some examples, the active configuration further comprises a relationship between a position of the nanorods 210 and the illumination source 250. For example, the active configuration may comprise the tips of the nanorods 210 being positioned to intersect the EM beam (e.g., an optical beam) emitted by the illumination source 250. The inactive configuration may comprise a position (not illustrated) of the tips at which the tips do not intersect the EM beam, for example.

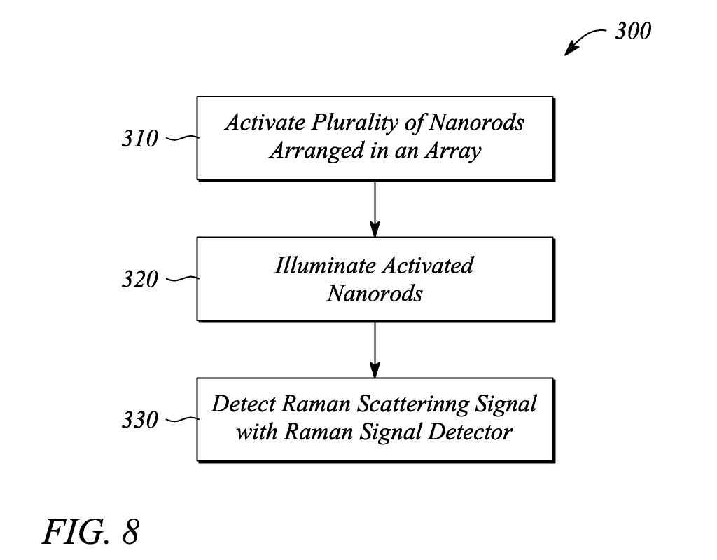

FIG. 8 illustrates a flow chart of a method 300 of surface enhanced Raman spectroscopy (SERS) employing nanorods, according to an example of the principles described herein. The method 300 of SERS employing nanorods comprises activating 310 a plurality of nanorods arranged in an array. Activating 310 moves the nanorods between an inactive configuration and an active configuration. Each nanorod of the plurality has a tip at a free end opposite an end of the nanorod that is attached to a substrate. In some examples, activating 310 may employ any of the activators 120, 220 described with respect to either of the nanorod SERS apparatus 100 and the nanorod SERS system 200, described above.

In particular, in some examples activating 310 may move the nanorods substantially once between the inactive and the active configuration. In other examples, activating 310 may move the nanorods substantially once between the active and the inactive configuration. In yet other examples, the movement between the active and inactive configurations provided by activating 310 may be substantially reversible.

In some examples, activating 310 a plurality of nanorods comprises employing a key to initiate activation 310. Possession of the key determines whether or not the method 300 of SERS employing nanorods may be performed. In particular, in some examples, a ‘user in possession of the key’ is defined as an ‘authorized user’ who may activate 310 the nanorods and perform the method 300 of SERS. An ‘unauthorized user’ by definition lacks the key and may not perform the method 300 of SERS. In other words, the key may prevent unauthorized activation 310, in some examples. In some examples, the key employed by activating 310 the nanorods may be substantially similar to the either the key 130 or the key 230 described above with respect to the nanorod SERS apparatus 100 and the nanorod SERS system 200, respectively.

In some examples, activating 310 a plurality of nanorods may comprise bending or straightening the nanorods using a bi-metallic material of the nanorods. In particular, for activation 310, a bent nanorod is straightened, a straightened nanorod is bent, or the nanorod is reversibly bent and straightened according to an action of the bi-metallic material as a function of temperature, in some examples. The bi-metallic material may comprise a coating or layers on one or more surfaces of the nanorods, for example. In another example, the bi-metallic material may be a structural portion or component of the nanorods themselves. In some examples that employ the bi-metallic material, the key may comprise a predetermined temperature that places the nanorods in the active configuration.

In some examples, activating 310 a plurality of nanorods comprises releasing a spring tension in the nanorods. Releasing the spring tension allows the nanorods to move from the inactive configuration to the active configuration. Specifically, in some examples, releasing the spring tension allows previously bent nanorods to substantially straighten into the active configuration. In another example, releasing the spring tension moves the nanorods from a first (e.g., initial) position to a second (e.g., final) position. In some of these examples, the nanorods pass through or by an intermediate position between the initial and final position. The intermediate position may be a predetermined position of the nanorods that represents the active configuration. For example, at the intermediate position, the nanorods or the tips of the nanorods may substantially intersect an illumination beam or signal to facilitate production of a Raman scattering signal. In others of these examples, the final position is or represents the active configuration.

Referring again to FIG. 8, the method 300 of SERS employing nanorods further comprises illuminating 320 the activated 310 plurality of nanorods, according to some examples. Illuminating 320 the activated nanorods produces a Raman scattering signal from an analyte adsorbed on the nanorod tips. In some examples, illuminating 320 the activated nanorods is provided by an illumination source such as, but not limited to, a laser that produces an optical beam (i.e., an EM beam).

In some examples, the method 300 of SERS employing nanorods further comprise detecting 330 the Raman scattering signal using a Raman signal detector. In some examples, the Raman scattering signal is preferentially directed into the Raman signal detector when the nanorods are in the active configuration. In other words, an angle between or a relative position of the nanorods and the Raman signal detector preferentially directs the Raman scattering signal into an input aperture of the Raman signal detector. Alternatively, when the nanorods are not in the active configuration, the Raman scattering signal may be directed away from the aperture and thus may not be detected by the Raman signal detector. In some examples, the Raman signal detector is substantially similar to the Raman signal detector 240 described above with respect to the nanorod SERS system 200.

Thus, there have been described examples of a nanorod SERS apparatus, a nanorod SERS system and a method of SERS using nanorods that are activated with a key. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A nanorod surface enhanced Raman spectroscopy (SERS) apparatus comprising:
a plurality of nanorods arranged in an array, each nanorod having a tip at a free end opposite to an end of the nanorod that is attached to a substrate, the tip being configured to adsorb an analyte;
an activator to move the nanorods of the plurality between an inactive configuration and an active configuration; and
a key to trigger the activator.

2. The nanorod SERS apparatus of claim 1, wherein the tip of the nanorods comprises a Raman-active material layer coating to further enhance Raman scattering from a vicinity of the tip.

3. The nanorod SERS apparatus of claim 1, wherein the nanorods further comprise a nanoparticle attached to the tip, the nanoparticle to adsorb the analyte.

4. The nanorod SERS apparatus of claim 3, wherein the active configuration comprises tips of adjacent nanorods being in close proximity to one another.

5. The nanorod SERS apparatus of claim 1, wherein the activator comprises a spring tension in nanorods that when released allows the nanorods to become substantially straightened into the active configuration, the nanorods being in the inactive configuration prior to being released.

6. The nanorod SERS of claim 5, wherein the key comprises a latch that constrains the nanorods until the latch is released to trigger action of the spring tension of the activator.

7. The nanorod SERS apparatus of claim 1, wherein the activator comprises a bi-metallic material of the nanorods, the bi-metallic material causing the nanorods to flex as a function of temperature, the key being a predetermined temperature of the bi-metallic material that flexes the nanorods into the active configuration.

8. The nanorod SERS apparatus of claim 1, wherein the activator comprises a microelectromechanical system (MEMS) actuator and the key comprises a driver that controls the actuator.

9. A nanorod SERS system comprising the nanorod SERS apparatus of claim 1, the nanorod SERS system further comprising a Raman signal detector to detect a preferentially directed Raman scattering signal emitted by the analyte to the Raman signal detector when the nanorods are in the active configuration.

10. The nanorod SERS system of claim 9 further comprising an illumination source to illuminate the tips of the nanorods in the active configuration to produce the Raman scattering signal of the analyte.

11. The nanorod SERS system of claim 1, wherein the movement between the inactive configuration and the active configuration is reversible by the activator.

12. A nanorod surface enhanced Raman spectroscopy (SERS) system comprising:
a plurality of nanorods arranged in an array, each nanorod having a tip at a free end opposite to an end of the nanorod that is attached to a substrate, the tip being configured to adsorb an analyte;
an activator to move the nanorods of the plurality between an inactive configuration and an active configuration when the activator is triggered by a key; and
a Raman signal detector to detect a Raman scattering signal from an adsorbed analyte on the nanorod tips,
wherein the active configuration facilitates detection of the Raman scattering signal by the Raman signal detector.

13. The nanorod SERS system of claim 12, wherein the activator comprises a spring tension in the nanorods that when released allows the nanorods to become substantially straightened into the active configuration, the nanorods being in the inactive configuration prior to being released, and wherein the key comprises a latch that constrains the nanorods in the inactive configuration until the latch is released.

14. The nanorod SERS system of claim 12, wherein the activator comprises a microelectromechanical system (MEMS) actuator, the key comprising a driver that controls the actuator.

15. The nanorod SERS system of claim 12, further comprising an illumination source configured to illuminate the tips of the nanorods, wherein the active configuration comprises a predetermined position of the nanorods between a first position and a second position defined by predetermined location of the nanorod tips relative to the illumination source.

16. The nanorod SERS system of claim 12, wherein the nanorods further comprise a nanoparticle attached to the tip, the nanoparticle to adsorb the analyte.

17. A method of surface enhanced Raman spectroscopy (SERS) employing nanorods, the method comprising:
activating a plurality of nanorods arranged in an array to move the nanorods between an inactive configuration and an active configuration triggered by a key, each nanorod having a tip at a free end opposite to an end of the nanorod that is attached to a substrate;
illuminating the activated plurality of nanorods to produce a Raman scattering signal from an analyte adsorbed on the nanorod tips; and
detecting the Raman scattering signal using a Raman signal detector when the nanorods are in the active configuration.

18. The method of SERS employing nanorods of claim 17, wherein activating a plurality of nanorods comprises using a bi-metallic material of the nanorods to flex the nanorods, the key comprising a predetermined temperature that causes the bi-metallic material to flex the nanorods into the active configuration.

19. The method of SERS employing nanorods of claim 17, wherein activating a plurality of nanorods comprises releasing a spring tension in the nanorods that allows previously bent nanorods to substantially straighten into the active configuration.

20. The method of SERS employing nanorods of claim 17, wherein the key prevents unauthorized activation.
